(19) United States
(12) Patent Application Publication
(10) Pub. No.: US 2007/0294541 A1
(43) Pub. Date: Dec. 20, 2007

(54) Methods and apparatus for encryption verification

(76) Inventor: Phani Bhushan Avadhanam, San Diego, CA (US)

Correspondence Address: QUALCOMM INCORPORATED, 5775 MOREHOUSE DR., SAN DIEGO, CA, 92121, US

(21) Appl. No.: 11/493,946

(22) Filed: Jul. 26, 2006

Related U.S. Application Data
(60) Provisional application No. 60/814,231, filed on Jun. 16, 2006.

(51) Int. Cl. G06F 12/14; H04K 1/00; H04L 9/32; G06F 11/30

(52) U.S. Cl. 713/189; 380/270

(57) ABSTRACT

Methods and apparatus for providing encryption verification. In an aspect, a method is provided for providing encryption verification. The method includes receiving at least one parameter associated with a flow, determining a key based on the at least one parameter, decrypting the flow using the key, and determining whether the flow was successfully decrypted. In another aspect, an apparatus is provided for providing encryption verification. The apparatus includes receiving logic configured to receive at least one parameter associated with a flow, encryption logic configured to determine a key based on the at least one parameter and to decrypt the flow using the key, and processing logic configured to determine whether the flow was successfully decrypted.

### CLAIM OF PRIORITY UNDER 35 U.S.C. §119

The present application for patent claims priority to Provisional Application Ser. No. 60/814,231, filed Jun. 16, 2006, and assigned to the assignee hereof and hereby expressly incorporated by reference herein.

### BACKGROUND

1. Field

The present application relates generally to the operation of communication systems, and more particularly, to methods and apparatus for encryption verification.

2. Background

Data networks, such as wireless communication networks, have to trade off between services customized for a single terminal and services provided to a large number of terminals. For example, the distribution of multimedia content to a large number of resource limited portable devices (subscribers) is a complicated problem. Therefore, it is very important for network administrators, content retailers, and service providers to have a way to distribute content and/or other network services in a fast and efficient manner and in such a way as to increase bandwidth utilization and power efficiency.

In current content delivery/media distribution systems, real time and non real time services are delivered to devices on a network in one or more content flows. For example, a communication network may utilize Orthogonal Frequency Division Multiplexing (OFDM) to provide communications between a network server and one or more mobile devices. This technology provides a transmission frame having data slots that are packed with services to be delivered over a distribution network in the form of one or more content flows.

Typically, the distributed content flows are encrypted to provide secure delivery. Thus, devices wishing to receive content generally have to register with a content delivery system in order to receive the keys needed to decrypt the content. As a result, in order to test and/or verify the encryption/decryption functions of any particular device, that device must first register with the distribution system to receive the necessary keys. It would, however, be desirable to verify the encryption/decryption functions of any particular device regardless of whether or not it is registered with a content distribution system. For example, such verification may improve device and/or network performance, or simply alert device users if their devices are not operating properly. Additionally, such verification would also help reduce device development time for device manufacturers.

Therefore, it would be desirable to have a system that operates to provide encryption verification of a device in a fast and efficient manner without requiring special device registrations.

### SUMMARY

In one or more embodiments, a verification system is provided that operates to provide encryption/decryption verification. For example, the system is operable to verify the decryption functions of devices in communication with a communication network. In an embodiment, the system utilizes parameters on a control channel to enable a device to determine a key to be used to decrypt a particular flow. The key is selected from a set of available keys that are well known. If decryption of a flow fails, an error notification is generated so that the device user or the communication network can take corrective action. As a result, the encryption/decryption functions of devices in communication with a network can be verified without requiring devices to register with specialized content distribution systems.

In an aspect, a method is provided for providing encryption verification. The method comprises receiving at least one parameter associated with a flow, determining a key based on the at least one parameter, decrypting the flow using the key, and determining whether the flow was successfully decrypted.

In another aspect, an apparatus is provided for providing encryption verification. The apparatus comprises receiving logic configured to receive at least one parameter associated with a flow, encryption logic configured to determine a key based on the at least one parameter and to decrypt the flow using the key, and processing logic configured to determine whether the flow was successfully decrypted.

In another aspect, an apparatus is provided for providing encryption verification. The apparatus comprises means for receiving at least one parameter associated with a flow, means for determining a key based on the at least one parameter, means for decrypting the flow using the key, and means for determining whether the flow was successfully decrypted.

In another aspect, a computer-readable medium is provided that has a computer program which when executed operates to provide encryption verification. The computer program comprises instructions for receiving at least one parameter associated with a flow, and instructions for determining a key based on the at least one parameter. The computer program also comprises instructions for decrypting the flow using the key, and instructions for determining whether the flow was successfully decrypted.

In another aspect, at least one processor is provided that is configured to perform a method for providing encryption verification. The method comprises receiving at least one parameter associated with a flow, determining a key based on the at least one parameter, decrypting the flow using the key, and determining whether the flow was successfully decrypted.

In another aspect, a method for providing encryption verification is provided. The method comprises selecting a key to encrypt a flow, identifying the key with at least one parameter associated with the flow, transmitting the flow, and transmitting the at least one parameter over a control channel.

In another aspect, an apparatus for encryption verification is provided. The apparatus comprises encryption logic configured to select a key to encrypt a flow, and to identify the key with at least one parameter associated with the flow, and a transmitter configured to transmit the flow over a broadcast channel and to transmit the at least one parameter over a control channel.

In another aspect, an apparatus for encryption verification is provided. The apparatus comprises means for selecting a key to encrypt a flow, means for identifying the key with at least one parameter associated with the flow. The apparatus also comprises means for transmitting the flow, and means for transmitting the at least one parameter over a control channel.

In another aspect, a computer-readable medium is provided that has a computer program which when executed operates to provide encryption verification. The computer program comprises instructions for selecting a key to encrypt a flow, instructions for identifying the key with at least one parameter associated with the flow, instructions for transmitting the flow, and instructions for transmitting the at least one parameter over a control channel.

In still another aspect, at least one processor configured to perform a method for providing encryption verification. The method comprises selecting a key to encrypt a flow, identifying the key with at least one parameter associated with the flow, transmitting the flow, and transmitting the at least one parameter over a control channel.

Other aspects of the embodiments will become apparent after review of the hereinafter set forth Brief Description of the Drawings, Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a network that comprises an embodiment of a verification system;

FIG. 2 shows an embodiment of an encryptor for use in a verification system;

FIG. 3 shows an embodiment of parameters for use in a verification system;

FIG. 4 shows an embodiment of a method for providing a verification system;

FIG. 5 shows an embodiment of a decryptor for use in a verification system;

FIG. 6 shows an embodiment of a method for providing a verification system;

FIG. 7 shows an embodiment of key associations for use in a verification system

FIG. 8 shows an embodiment of an encryptor for use in a verification system; and

FIG. 9 shows an embodiment of a decryptor for use in a verification system.

### DETAILED DESCRIPTION

In one or more embodiments, a verification system is provided that operates to verify encryption/decryption functions of devices in a communication network. For example, the verification system allows verification of the decryption functions of devices in a communication network. The system provides this verification without requiring the devices to perform any special registration process, which is normally used to authorize devices to subscribe to receive content. Thus, the decryption functions of devices in communication with the network can be tested regardless of whether those devices are authorized to receive content.

In an embodiment, the system utilizes one or more parameters to determine a key to be used to decrypt a flow. The one or more parameters comprise a key reference indicator, a flow identifier, a flag associated with a flow, or any other binding type associated with a particular flow. The one or more parameters are transmitted on a control channel that is part of normal network communications. Devices in communication with the network can receive the one or more parameters and determine a selected key, which is then used to decrypt a flow. If the flow cannot be decrypted successfully, an error notification is generated.

It should be noted that encryption keys may be processed in any number of ways when being used to encrypt/decrypt content. For example, in a communication system a first key, known as a service key, may be processed by an algorithm to produce a second key, known as an encrypted working key. The encrypted working key is then use by the communication system. For the purpose of this description, the processing of service keys to produce encrypted working keys is not essential to the operation of the embodiments, and therefore is not described in detailed herein. Thus, the system operates to allow a device to determine a key with which the decryption functions of the device may be tested regardless of how the determined key may be process to produce one or more other keys.

The system is especially well suited for use in wireless network environments, but may be used in any type of network environment, including but not limited to, communication networks, public networks, such as the Internet, private networks, such as virtual private networks (VPN), local area networks, wide area networks, long haul networks, or any other type of network.

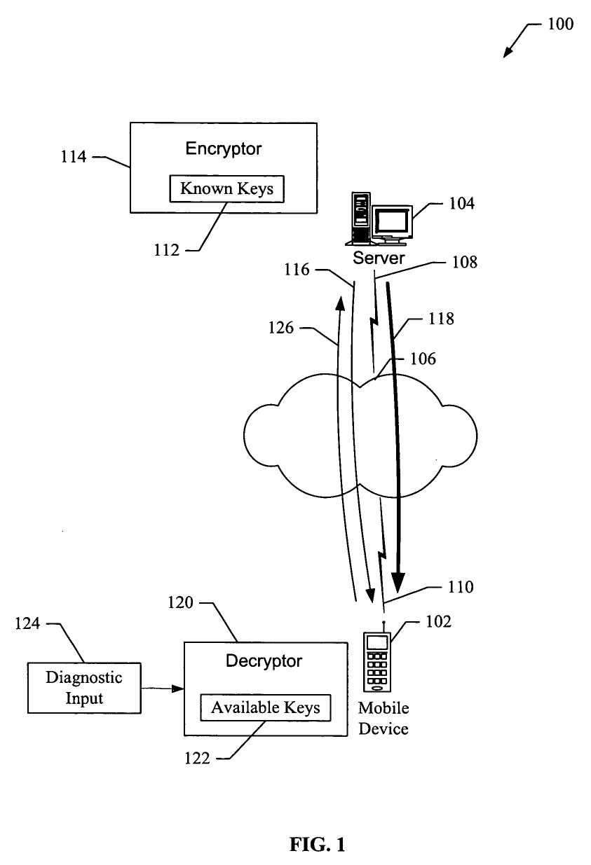

FIG. 1 shows a network 100 that comprises an embodiment of a verification system. The network 100 comprises mobile device 102, server 104, and a communication network 106. For the purpose of this description, it will be assumed that the network 106 operates to provide communications between the server 104 and one or more of the mobile devices using orthogonal frequency division multiplexing (OFDM) technology; however, embodiments of the verification system are suitable for use with other transmission technologies as well.

In an embodiment, the server 104 operates to provide content and/or services that may be subscribed to by devices in communication with the network 106. The server 104 is coupled to the network 106 through the communication link 108. The communication link 108 comprises any suitable communication link, such as a wireless link based on OFDM technology that operates to allow the server 104 to communicate with the network 106. The network 106 comprises any combination of wired and/or wireless networks that allows content and/or services to be delivered from the server 104 to devices in communication with the network 106, such as the device 102.

The device 102 in this embodiment comprises a mobile telephone that communicates with the network 106 through the wireless link 110. In an embodiment, the wireless link 110 comprises a forward communication link based on OFDM technology and a reverse communication link based on any suitable reverse link technology. However, in other embodiments the wireless link 110 may comprise other suitable wired or wireless technologies that operate to allow devices to communicate with the network 106.

It should be noted that the network 106 may communicate with any number and/or types of devices within the scope of the embodiments. For example, other devices suitable for use in embodiments of the verification system include, but are not limited to, a personal digital assistant (PDA), email device, pager, a notebook computer, mp3 player, video player, or a desktop computer.

It will be assumed that the server 104 is part of a content distribution system that operates to distribute content to devices in communication with the network 106. The content is delivered in the form of content flows comprising audio and video information formatted in any suitable format. In order to subscribe to receive content, devices in communication with the network go through a registration process during which they become authorized. During the registration process, encryption keys are distributed to authorized devices. These keys are used by the authorized devices to decrypt received content flows. However, it is desirable to test the decryption functionality of devices in communication with the network 106 without requiring those devices to register with the distribution system to obtain the authorized keys.

In one or more embodiments, the verification system operates to verify the decryption functionality of devices in communication with the network 106 without requiring those devices to register with the distribution system. In an embodiment, the server 104 comprises known encryption keys 112. For example, the keys 112 are well known keys in the communication industry and are published or made available to communication system providers and manufacturers. For example, the keys may be specified by an industry wide standardization body.

The server 104 also comprises an encryptor 114 that operates to select one or more of the known keys 112 with which to encrypt one or more flows. For example, a key may be selected using any type of selection process. The one or more flows that are to be encrypted may be specified by a Test Application Protocol (TAP), which specifies test flows for a variety of network purposes. It should also be noted that embodiments of the verification system operate to provide encryption verification using either specialized TAP flows, or any other type of flow, such as an available audio or video flow.

Once a key is selected, the encryptor 114 uses one or more parameters associated with the flow to identify the key that has been selected. In an embodiment, the one or more parameters comprise a reference indicator that indicates the selected key from a known list of keys. In another embodiment, the one or more parameters comprise a flag associated with the flow that indicates that the flow was encrypted with a pre-selected key. In still another embodiment, the one or more parameters comprise a flow identifier, which can be used to select a particular key. In still another embodiment, the one or more parameters comprise any other binding type associated with the flow. For example, the binding type may be a flow format or any other binding type associated with the flow, which is used to identify a particular key.

The encryptor 114 operates to provide the one or more parameters on a control channel 116. The control channel 116 is distributed over the network 106 and devices in communication with the network 106 are able to listen and receive information on this channel. Additionally, the encryptor 114 operates to use the selected key to encrypt one or more selected flows and provide those encrypted flows over a broadcast channel 118. The broadcast channel 118 is also distributed over the network 106 to devices in communication with the network 106.

The device 102 operates on the network 106 and is able to monitor the control channel 116 and receive flows over the broadcast channel 118. Because these functions are part of normal network communications, the device 102 does not have to perform any special registration with a content distribution system to monitor the control channel 116 or receive the broadcast channel 118.

The device 102 comprises a decryptor 120 that operates to decrypt received content flows. The decryptor 120 monitors the control channel 116 and receives the one or more parameters associated with one or more of the content flows being broadcast on the broadcast channel 118. The decryptor 120 has access to available keys 122. For example, the available keys 122 may comprise some or all of the known keys 112. The decryptor 120 operates to identify a select key from the available keys 122 based on the received one or more parameters. For example, in an embodiment, the parameters comprise a key reference indicator. The decryptor 120 operates to use this reference indicator to identify a selected key from the available keys 122. In an embodiment, the parameters comprise a flag. For example, a pre-selected key can be used to decrypt any flow having the flag set. Thus, the decryptor 120 determines if the flag associated with a particular flow is set, and if it is, the decryptor 120 uses the pre-selected key to decode the flow. In still another embodiment, some other binding type associated with the flow is provided over the control channel 116. The decryptor 120 operates to monitor the control channel and process these binding types to determine a particular key. Based the received binding type, a key is selected from the available keys 122 to decode a flow.

In still another embodiment, the decryptor 120 receives input from a diagnostic interface (I/F) 124. For example, the diagnostic I/F allows a system administrator or technician to set or pre-program associations between binding types and selected keys. Thus, flows associated with a particular binding type will be decrypted with a pre-selected key.

Once a key is determined, the decryptor 120 attempts to decrypt a selected flow received over the broadcast channel 118. If the decryption fails, the decryptor 120 generates an error notification. In an embodiment, the error notification comprises an indicator sent to the device user that indicates that a decryption error has occurred. The device user may then seek technical assistance for the device. In another embodiment, the decryptor 120 transmits an error notification to the server 104 as shown at 126. The error notification notifies the server 104 that the device's decryption functions are not operating properly. The server 104 may then take any desired action.

Therefore, embodiments of a verification system operate to provide encryption verification by performing one or more of the following functions at a transmitting server.
a. Selecting a key from known keys and encrypting a flow. (i.e., a TAP flow)
b. Generating one or more parameters that identify the key. For example, the parameters comprise a key reference indicator, a flow identifier, a flag, or any binding type associated with the flow.
c. Transmitting the flow.
d. Transmitting the parameters over a control channel.
e. Receiving an error notification if decryption at a device fails.

Therefore, embodiments of a verification system operate to provide encryption verification by performing one or more of the following functions at a receiving device.
a. Receiving a flow (i.e., receiving a TAP flow over a broadcast channel)
b. Receiving one or more parameters associated with the flow over a control channel. For example, the parameters comprise a key reference indicator, a flow identifier, a flag, or any binding type associated with the flow.
c. Receiving an optional input from a diagnostic I/F that identifies a key associated with a particular binding type.
d. Selecting a key from available keys based on the received parameters.
e. Decrypting the flow using the selected key.
f. Generating an error notification if the decryption is not successful.

Therefore, embodiments of a verification system operate to provide encryption verification. It should be noted that the verification system is not limited to the implementations described with reference to FIG. 1, and that other implementations are possible within the scope of the embodiments.

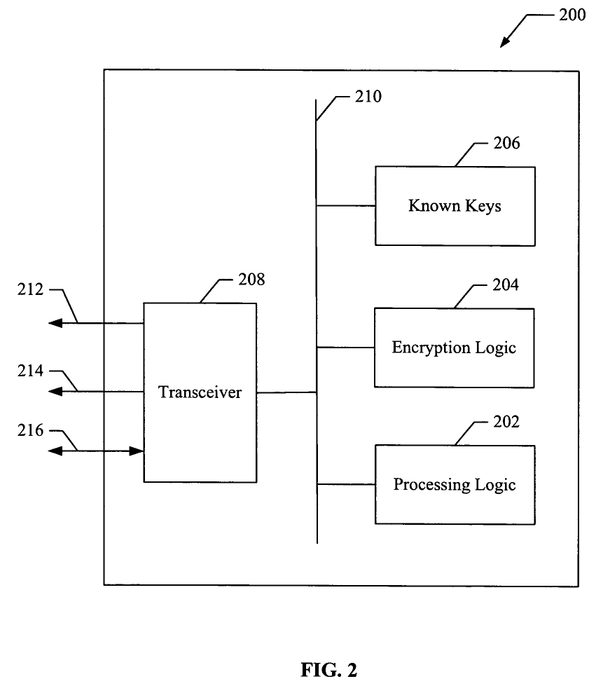

FIG. 2 shows an embodiment of an encryptor 200 for use in a verification system. For example, the encryptor 200 is suitable for use as the encryptor 114 shown in FIG. 1. The encryptor 200 comprises processing logic 202, encryption logic 204, known keys 206, and transceiver 208 all coupled to a data bus 210.

The transceiver logic 208 comprises any suitable hardware and/or software that operate to allow the encryptor 200 to communicate over a network. In an embodiment, the transceiver logic 208 comprises logic operable to transmit one or more flows over a broadcast channel 212. For example, the broadcast channel 212 may be the broadcast channel 118 shown in FIG. 1. The transceiver logic 408 also comprises control channel logic operable to send parameters over a control channel 214. The transceiver logic 208 also comprises logic operable to send and receive information over a unicast transmission channel 216. Thus, the transceiver logic 408 allows the encryptor 200 to communicate with a network using many types of communication channels and technologies.

The processing logic 202 comprises a CPU, processor, gate array, hardware logic, virtual machine, software, and/or any combination of hardware and software. The processing logic 202 operates to control the transceiver 208 to send and receive information over a communication network using the broadcast channel 212, control channel 214, and/or the unicast channel 216.

The encryption logic 204 comprises any suitable hardware and/or software that operates to perform encryption of one or more flows. For example, the flows may be TAP flows or any other available audio or video flow. In an embodiment, the encryption logic 204 operates to select a key from the known keys 206 using any desired selection technique. The selected key is used to encrypt a flow.

The encryption logic 204 operates to generate one or more parameters that identify the selected key. For example, the parameters comprise but are not limited to, a key reference, flow identifier, a flag, or other binding type. The encryption logic passes the parameters to the processing logic 202, which in turn controls the transceiver 208 to transmit the parameters on the control channel 214. The encryption logic 204 also operates to encrypt a flow using the selected key.

During operation, the encrypted flow is transmitted over a network the broadcast channel 212. Devices listening on the control channel 214 operate to receive the one or more parameters, determine a decryption key, and decrypt the broadcast flow. If the decryption is unsuccessful, a device may operate to transmit an error notification that is received by the transceiver logic 208 using the unicast channel 216. The processing logic 202 may then take any necessary action.

In an embodiment, the verification system comprises a computer program having one or more program instructions (“instructions”) stored on a computer-readable medium, which when executed by at least one processor, provides the functions of the verification system described herein. For example, instructions may be loaded into the encryptor 200 from a computer-readable media, such as a floppy disk, CDROM, memory card, FLASH memory device, RAM, ROM, or any other type of memory device. In another embodiment, the instructions may be downloaded into the encryptor 200 from an external device or network resource. The instructions, when executed by at least one processor at the encryptor 200 operate to provide embodiments of a verification system as described herein.

Thus, the encryptor 200 operates to broadcast an encrypted flow and transmit one or more parameters over a control channel that identifies a key to be used to decrypt the flow. It should be noted that the encryptor 200 is just one implementation and the other implementations are possible within the scope of the embodiments.

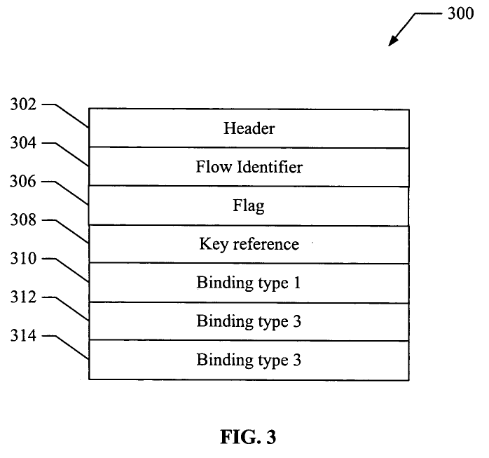

FIG. 3 shows an embodiment of parameters 300 for use in a verification system. For example, the parameters 300 are suitable for transmission over the control channel 116 shown in FIG. 1.

The parameters 300 comprise a header 302 that identifies the parameters. The header 302 may comprises any suitable information in any suitable format to indicate that it represents the start of one or more parameters used in a verification system. After the header 202, the parameters 300 comprise a flow identifier 304 that identifies a particular flow. For example, the flow may be a TAP flow or any other suitable flow. A flag 306 follows the flow identifier. The flag 306 is used to indicate that the flow identified by the flow identifier 304 was encrypted with a pre-selected key.

In an embodiment, a key reference 308 is provided that references a particular key from a list of keys. For example, a device may have a list of available keys, and the key reference 308 is used to select a particular key from the list. In another embodiment, one or more binding types (310-314) are provided that are used to select a particular key. For example, the system may define one or more binding types to be associated with a particular key.

It should be noted that the parameters 300 represents just one implementation and that other implementations are possible within the scope of the embodiments. For example, in other embodiments, the parameters 300 may comprise additions, deletions, changes, or modifications to the parameters shown.

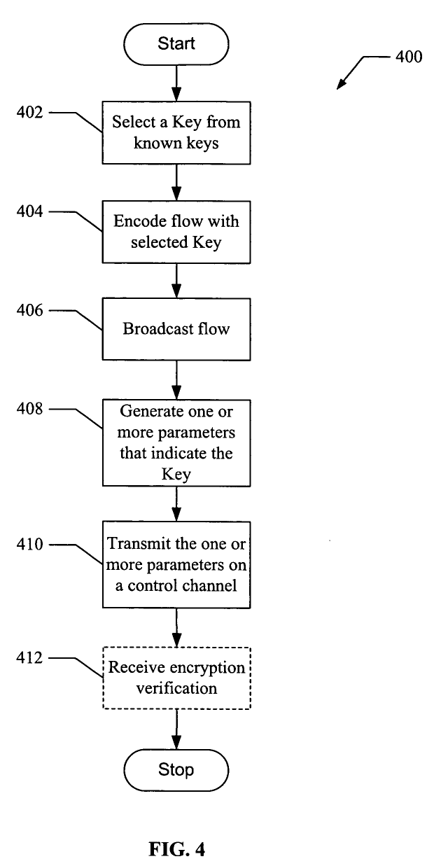

FIG. 4 shows an embodiment of a method 400 for providing a verification system. For example, in an embodiment, the encryptor 200 is configured to perform the method 400 as describe below.

At block 402, a key is selected from known keys. For example, the known keys comprise a list of industry standard keys. In an embodiment, the encryption logic 204 operates to select the key from the known keys 206.

At block 404, one or more flows are encrypted using the selected key. For example, the flows may be TAP flows or any other available flow, such as an audio or video flow. In an embodiment, the flow is encrypted by the encryption logic 204.

At block 406, the encrypted flow is transmitted over a network. For example, the encrypted flow is broadcast over a network broadcast channel so that devices in communication with the network may receive the flow without having to perform any special registration procedures. In an embodiment, the flow is broadcast over the broadcast channel 212 by the transceiver logic 208.

At block 408, one or more parameters are generated that indicate the selected key. For example, the parameters comprise, but are not limited to, a key reference, a flow identifier, a flag, or one or more binding types. In an embodiment, the encryption logic 204 operates to generate the one or more parameters, which may be formatted as shown in FIG. 3.

At block 410, the parameters are transmitted on a control channel. For example, the network provides a control channel which devices in communication with the network can monitor to received various types of information. In an embodiment, the transceiver logic 208 operates to transmit the parameters on the control channel 214.

At block 412, in an optional operation, one or more error notifications are received. For example, devices which are unable to decrypt the broadcasted flow transmit an error notification that is received by the transceiver logic 208 using the unicast channel 216. In an embodiment, the error notifications that are received are passed to the processing logic 202 for further processing. The processing logic 202 may operate to notify network administrators regarding the error notifications or perform any other operations in response to the error notifications.

Thus, the method 400 operates to provide an embodiment of a verification system. It should be noted that the method 400 represents just one implementation and the changes, additions, deletions, combinations or other modifications of the method 400 are possible within the scope of the embodiments.

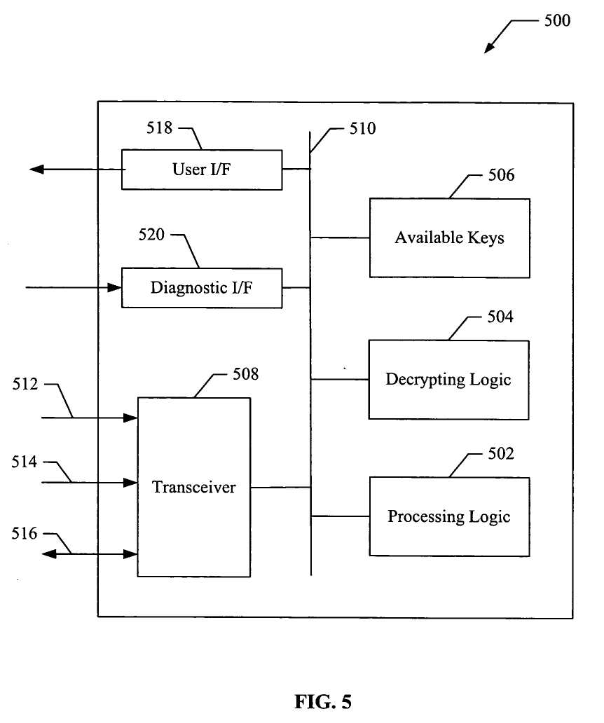

FIG. 5 shows an embodiment of a decryptor 500 for use in a verification system. For example, the decryptor 500 is suitable for use as the decryptor 120 shown in FIG. 1. The decryptor 500 comprises processing logic 502, decrypting logic 504, available keys 506, and transceiver 508 all coupled to a data bus 510. The encryptor 500 also comprises user I/F 518 and diagnostic I/F 520, which are also coupled to the data bus 510.

The available keys 506 comprise any suitable keys that are available for use by the decryptor 500 to decrypt information. For example, the available keys 506 may be installed in the decryptor 500 during manufacture, downloaded from a network, or installed from another device.

The diagnostic I/F 520 comprises any suitable hardware and/or software that operates to allow the decryptor 500 to communicate with a diagnostic device. For example, a system administrator may access the decryptor 500 through the diagnostic I/F 520 and install associations that associate keys to be used with selected flow binding types. For example, a flow having a selected binding type will be decrypted using a pre-selected key.

The transceiver logic 508 comprises any suitable hardware and/or software that operate to allow the decryptor 500 to communicate over a network. In an embodiment, the transceiver logic 508 comprises logic operable to receive one or more flows over a broadcast channel 512. For example, the broadcast channel 512 may be the broadcast channel 118 shown in FIG. 1. The transceiver logic 508 also comprises control channel logic operable to receive information and/or parameters over a control channel 514. The transceiver logic 508 also comprises logic operable to send and receive information over a unicast transmission channel 516. Thus, the transceiver logic 508 allows the decryptor 500 to communicate with a network using many types of communication channels and technologies.

The decrypting logic 504 comprises any suitable hardware and/or software that operate to decrypt received flows using keys selected from the available keys 506. In an embodiment, the decrypting logic 504 operates to select a key from the available keys 506 based on parameters received over the control channel 514. For example, the parameters comprise, but are not limited to, a key reference, flow identifier, a flag, or any bind types.

The processing logic 502 comprises a CPU, processor, gate array, hardware logic, virtual machine, software, and/or any combination of hardware and software. The processing logic 502 operates to process error notifications that are generated should decryption of a selected flow fail.

During operation, the decryptor 500 receives a flow over a broadcast channel, for example, the broadcast channel 512. In an embodiment, the flow is a TAP flow transmitted from a network server. The decrypting logic 504 monitors the control channel 514 to obtain one or more parameters associated with the flow. For example, the parameters may comprise parameters 300 described in FIG. 3. The decrypting logic 504 processes the received parameters to determine a key with which to decrypt the received flow. In an embodiment, the decrypting logic 504 selects the key from the available keys 506 based on a key reference, flow identifier, a flag, or any other binding type provided by the received parameters. For example, in an embodiment, the parameters may provide a selected binding type and the decrypting logic 504 selects a key from the available keys 506 based on an associations received through the diagnostic I/F 520. Thus, a particular key is selected based on the received parameters.

Once a key is selected, the flow is decrypted by the decrypting logic 504. If the decryption is not successful, the decrypting logic 504 notifies the processing logic 502. The processing logic 502 operates to generate an error notification that is provided to a device user through the user I/F 518. For example, the user I/F 518 comprises hardware and/or software operable to render images and/or sounds on a device. In another embodiment, the processing logic 502 controls the transceiver logic 508 to transmit the error notification over the unicast channel 516 to a network server.

In an embodiment, the verification system comprises a computer program having one or more program instructions (“instructions”) stored on a computer-readable medium, which when executed by at least one processor, provides the functions of the verification system described herein. For example, instructions may be loaded into the decryptor 500 from a computer-readable media, such as a floppy disk, CDROM, memory card, FLASH memory device, RAM, ROM, or any other type of memory device. In another embodiment, the instructions may be downloaded into the decryptor 500 from an external device or network resource. The instructions, when executed by at least one processor at the decryptor 500 operate to provide embodiments of a verification system as described herein.

Thus, the decryptor 500 operates to select a key based on parameters received on a control channel. The key is used to decrypt a received flow and if the decryption is unsuccessful, an error notification is generated. It should be noted that the decryptor 500 is just one implementation and the other implementations are possible within the scope of the embodiments.

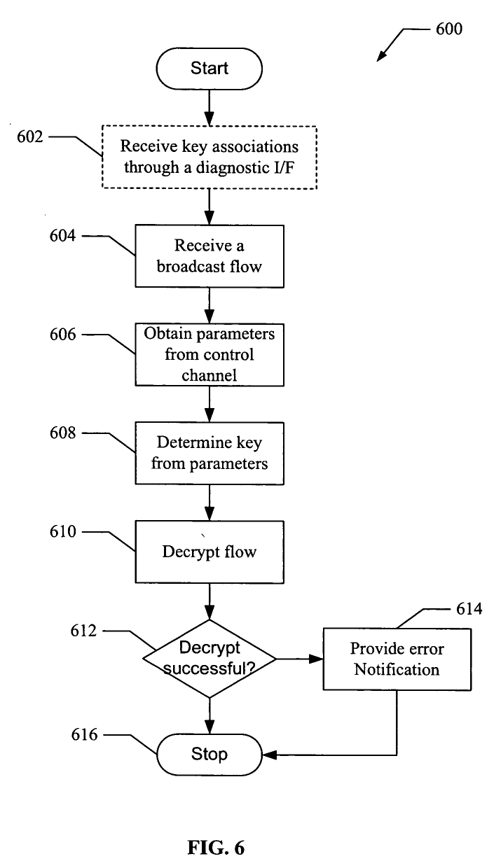

FIG. 6 shows an embodiment of a method 600 for providing a verification system. For example, in an embodiment, the decryptor 500 is configured to perform the method 600 as describe below.

At block 602, in an optional operation, one or more key associations are received over a diagnostic I/F. For example, the key associations associate a particular key with a particular binding type. In an embodiment, the key associations are provided by the diagnostic I/F 520.

At block 604, a broadcast flow is received. For example, the flow may be a TAP flow received over a broadcast channel. In an embodiment, the flow is received by the transceiver logic 508 over the broadcast channel 512.

At block 606, parameters are obtained over a control channel. For example, the parameters comprise but are not limited to, a key reference, flow identifier, a flag, or any binding type. In an embodiment, the decryption logic 504 operates to obtain the parameters from the control channel 514 provided by the transceiver logic 508.

At block 608, a key is determined. For example, the parameters are used to select a key to be used to decrypt the received flow. In an embodiment, the decryption logic 504 processes the parameters to select a key from the available keys 506. For example, a key reference, a flow identifier, a flag, or flow binding type is used to select the key from the available keys 506.

At block 610, the received flow is decrypted. In an embodiment, the decryption logic 504 operates to decrypt the received flow using the selected key.

At block 612, a test is performed to determine whether decryption was successful. In an embodiment, the decryption logic 504 operates to determine if the decryption of the flow was successful. If the decryption was successful, the method stops are block 616. If the decryption was not successful, the method proceeds to block 614.

At block 614, an error notification is generated. In an embodiment, the processing logic 502 operates to generate an error notification that is provided to the device user through the user I/F 518. In another embodiment, the processing logic 502 generates an error notification that is transmitted to a network server by the transceiver logic 508 using the unicast channel 516.

Thus, the method 600 operates to provide an embodiment of a verification system. It should be noted that the method 600 represents just one implementation and the changes, additions, deletions, combinations or other modifications of the method 600 are possible within the scope of the embodiments.

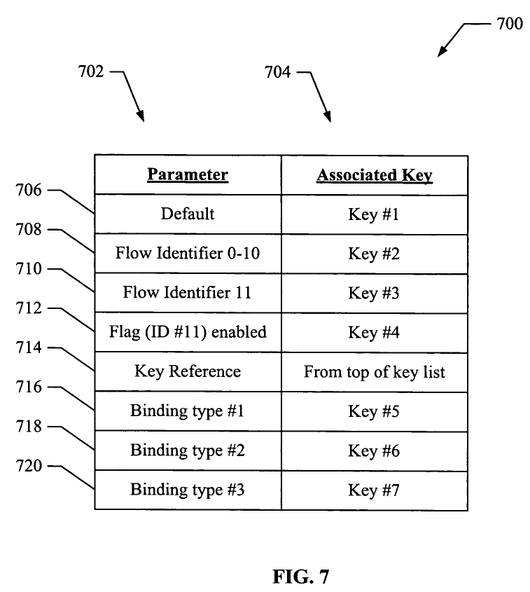

FIG. 7 shows an embodiment of key associations 700 for use in a verification system. For example, the key associations 700 may be received by the diagnostic I/F 520 and processed by the decryption logic 504 to select a particular key based on one or more received parameters.

The key associations 700 comprise parameters 702 that are matched with an associated key 704. The parameters 702 comprise a default parameter 706, a range of flow identifiers 708, a particular flow identifier 710, a flag 712 that is associated with the flow identifier 710, a key reference 714 that provides a reference from the top of a key list, and binding types (716-720).

In an embodiment, the key associations 700 may be updated or changes through the diagnostic I/F 520. For example, a system administrator may change, add, delete, or otherwise modify the keys associated with any parameters shown in the key associations 700 by using the diagnostic I/F 520. Thus, for example, a flow having flow identifier 11 (as shown at 710) is associated with key #3. If the flag 712 is enabled, that flow would then be associated with key #4. A system administrator could change those key associations using the diagnostic I/F 520 so that different keys could be identified in any of the associations.

It should be noted that the key associations 700 are just one implementation and that other implementations are possible within the scope of the embodiments.

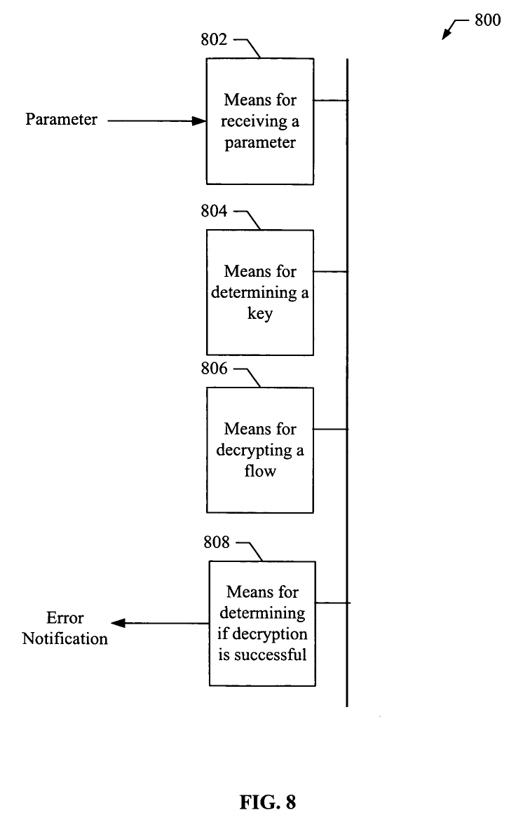

FIG. 8 shows an embodiment of a verification system 800. The verification system 800 comprises means (802) for receiving a parameter, means (804) for determining a key, means (806) for decrypting a flow, and means (808) for determining if decryption is successful. For example, in an embodiment, the means 802 comprises transceiver logic 508, the means 804 comprises decryption logic 504, the means 806 comprises the decryption logic 506, and the means 808 comprises the processing logic 502.

In another embodiment, the means (802-808) are implemented by at least one processor configured to execute program instructions to provide embodiments of a verification system as described herein.

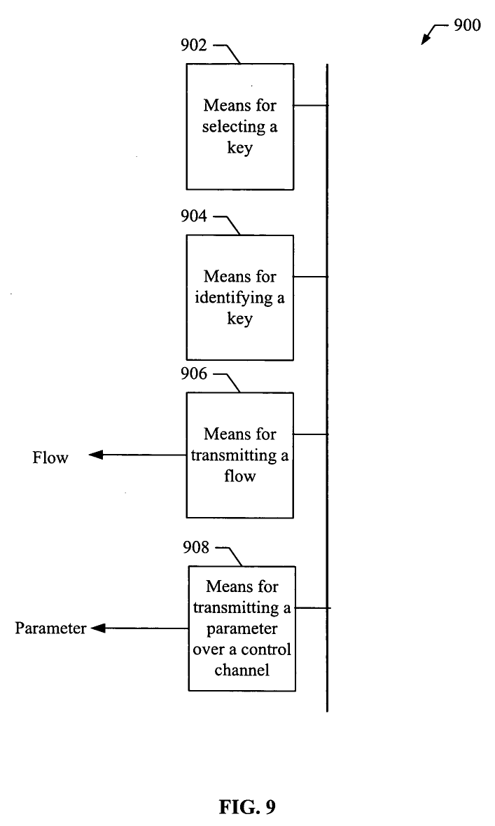

FIG. 9 shows an embodiment of a verification system 900. The verification system 900 comprises means (902) for selecting a key, means (904) for identifying a key, means (906) for transmitting a flow, and means (908) for transmitting a parameter. For example, in an embodiment, the means 902 comprises the encryption logic 204, the means 904 comprises the encryption logic 204, the means 906 comprises the transceiver 208, and the means 908 comprises the transceiver 208.

In another embodiment, the means (902-908) are implemented by at least one processor configured to execute program instructions to provide embodiments of a verification system as described herein.

Therefore various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

Accordingly, while embodiments of a verification system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for providing encryption verification, the method comprising:
receiving at least one parameter associated with a flow;
determining a key based on the at least one parameter;
decrypting the flow using the key; and
determining whether the flow was successfully decrypted.

2. The method of claim 1, further comprising providing an error notification if the flow was not successfully decrypted.

3. The method of claim 1, further comprising receiving the at least one parameter over a control channel.

4. The method of claim 1, further comprising receiving one or more key associations over a diagnostic interface.

5. The method of claim 1, wherein said determining comprises selecting the key from one or more available keys based on the at least one parameter.

6. The method of claim 1, wherein said determining comprises determining the key based on the at least one parameter, wherein the at least one parameter comprises a selected binding type.

7. The method of claim 1, wherein said determining comprises determining the key based on the at least one parameter, wherein the at least one parameter comprises a flag.

8. Apparatus for providing encryption verification, the apparatus comprising:
receiving logic configured to receive at least one parameter associated with a flow;
encryption logic configured to determine a key based on the at least one parameter and decrypt the flow using the key; and
processing logic configured to determine whether the flow was successfully decrypted.

9. The apparatus of claim 8, wherein said processing logic is configured to provide an error notification if the flow was not successfully decrypted.

10. The apparatus of claim 8, wherein said receiving logic is configured to receive the at least one parameter over a control channel.

11. The apparatus of claim 8, further comprising a diagnostic interface configured to receive one or more key associations.

12. The apparatus of claim 8, wherein said encryption logic is configured to select the key from one or more available keys based on the at least one parameter.

13. The apparatus of claim 8, wherein said encryption logic is configured to determine the key based on the at least one parameter, wherein the at least one parameter comprises a selected binding type.

14. The apparatus of claim 8, wherein said encryption logic is configured to determine the key based on the at least one parameter, wherein the at least one parameter comprises a flag.

15. Apparatus for providing encryption verification, the apparatus comprising:
means for receiving at least one parameter associated with a flow;
means for determining a key based on the at least one parameter;
means for decrypting the flow using the key; and
means for determining whether the flow was successfully decrypted.

16. The apparatus of claim 15, further comprising means for providing an error notification if the flow was not successfully decrypted.

17. The apparatus of claim 15, further comprising means for receiving the at least one parameter over a control channel.

18. The apparatus of claim 15, further comprising means for receiving one or more key associations over a diagnostic interface.

19. The apparatus of claim 15, wherein said means for determining comprises means for selecting the key from one or more available keys based on the at least one parameter.

20. The apparatus of claim 15, wherein said means for determining comprises means for determining the key based on the at least one parameter, wherein the at least one parameter comprises a selected binding type.

21. The apparatus of claim 15, wherein said means for determining comprises means for determining the key based on the at least one parameter, wherein the at least one parameter comprises a flag.

22. A computer-readable medium having a computer program which when executed operates to provide encryption verification, the computer program comprising:
instructions for receiving at least one parameter associated with a flow;
instructions for determining a key based on the at least one parameter;
instructions for decrypting the flow using the key; and
instructions for determining whether the flow was successfully decrypted.

23. The computer program of claim 22, further comprising instructions for providing an error notification if the flow was not successfully decrypted.

24. The computer program of claim 22, further comprising instructions for receiving the at least one parameter over a control channel.

25. The computer program of claim 22, further comprising instructions for receiving one or more key associations over a diagnostic interface.

26. The computer program of claim 22, wherein said instructions for determining comprise instructions for selecting the key from one or more available keys based on the at least one parameter.

27. The computer program of claim 22, wherein said instructions for determining comprise instructions for determining the key based on the at least one parameter, wherein the at least one parameter comprises a selected binding type.

28. The computer program of claim 22, wherein said instructions for determining comprise instructions for determining the key based on the at least one parameter, wherein the at least one parameter comprises a flag.

29. At least one processor configured to perform a method for providing encryption verification, the method comprising:
receiving at least one parameter associated with a flow;
determining a key based on the at least one parameter;
decrypting the flow using the key; and
determining whether the flow was successfully decrypted.

30. The method of claim 29, further comprising providing an error notification if the flow was not successfully decrypted.

31. The method of claim 29, further comprising receiving the at least one parameter over a control channel.

32. The method of claim 29, further comprising receiving one or more key associations over a diagnostic interface.

33. The method of claim 29, wherein said determining comprises selecting the key from one or more available keys based on the at least one parameter.

34. The method of claim 29, wherein said determining comprises determining the key based on the at least one parameter, wherein the at least one parameter comprises a selected binding type.

35. The method of claim 29, wherein said determining comprises determining the key based on the at least one parameter, wherein the at least one parameter comprises a flag.

36. A method for providing encryption verification, the method comprising:
selecting a key to encrypt a flow;
identifying the key with at least one parameter associated with the flow;
transmitting the flow; and
transmitting the at least one parameter over a control channel.

37. The method of claim 36, further comprising receiving an error notification if the flow was not successfully decrypted.

38. The method of claim 36, further comprising selecting the key from one or more known keys.

39. The method of claim 36, wherein said identifying comprises identifying the key with the at least one parameter, wherein the at least one parameter comprises a selected binding type associated with the flow.

40. The method of claim 36, wherein said identifying comprises identifying the key with the at least one parameter, wherein the at least one parameter comprises a flag.

41. The method of claim 36, wherein said transmitting comprises broadcasting the flow over a broadcast channel.

42. Apparatus for providing encryption verification, the apparatus comprising:
encryption logic configured to select a key to encrypt a flow, and to identify the key with at least one parameter associated with the flow; and
a transmitter configured to transmit the flow over a broadcast channel and to transmit the at least one parameter over a control channel.

43. The apparatus of claim 42, further comprising a receiver configured to receive an error notification if the flow was not successfully decrypted.

44. The apparatus of claim 42, wherein said encryption logic is configured to select the key from one or more known keys.

45. The apparatus of claim 42, wherein the at least one parameter comprises a selected binding type associated with the flow.

46. The apparatus of claim 42, wherein the at least one parameter comprises a flag.

47. Apparatus for providing encryption verification, the apparatus comprising:
means for selecting a key to encrypt a flow;
means for identifying the key with at least one parameter associated with the flow;
means for transmitting the flow; and
means for transmitting the at least one parameter over a control channel.

48. The apparatus of claim 47, further comprising means for receiving an error notification if the flow was not successfully decrypted.

49. The apparatus of claim 47, further comprising means for selecting the key from one or more known keys.

50. The apparatus of claim 47, wherein said means for identifying comprises means for identifying the key with the at least one parameter, wherein the at least one parameter comprises a selected binding type associated with the flow.

51. The apparatus of claim 47, wherein said means for identifying comprises means for identifying the key with the at least one parameter, wherein the at least one parameter comprises a flag.

52. The apparatus of claim 47, wherein said means for transmitting comprises means for broadcasting the flow over a broadcast channel.

53. A computer-readable medium having a computer program which when executed operates to provide encryption verification, the computer program comprising:
instructions for selecting a key to encrypt a flow;
instructions for identifying the key with at least one parameter associated with the flow;
instructions for transmitting the flow; and
instructions for transmitting the at least one parameter over a control channel.

54. The computer program of claim 53, further comprising instructions for receiving an error notification if the flow was not successfully decrypted.

55. The computer program of claim 53, further comprising instructions for selecting the key from one or more known keys.

56. The computer program of claim 53, wherein said instructions for identifying comprise instructions for identifying the key with the at least one parameter, wherein the at least one parameter comprises a selected binding type associated with the flow.

57. The computer program of claim 53, wherein said instructions for identifying comprise instructions for identifying the key with the at least one parameter, wherein the at least one parameter comprises a flag.

58. The computer program of claim 53, wherein said instructions for transmitting comprise instructions for broadcasting the flow over a broadcast channel.

59. At least one processor configured to perform a method for providing encryption verification, the method comprising:
selecting a key to encrypt a flow;
identifying the key with at least one parameter associated with the flow;
transmitting the flow; and
transmitting the at least one parameter over a control channel.

60. The method of claim 59, further comprising receiving an error notification if the flow was not successfully decrypted.

61. The method of claim 59, further comprising selecting the key from one or more known keys.

62. The method of claim 59, wherein said identifying comprises identifying the key with the at least one parameter, wherein the at least one parameter comprises a selected binding type associated with the flow.

63. The method of claim 59, wherein said identifying comprises identifying the key with the at least one parameter, wherein the at least one parameter comprises a flag.

64. The method of claim 59, wherein said transmitting comprises broadcasting the flow over a broadcast channel.
